(19) United States
(12) Patent Application Publication
(10) Pub. No.: US 2004/0248462 A1
(43) Pub. Date: Dec. 9, 2004

(54) Modular wiring harness and power cord for vending machines

(76) Inventors: Jonathan T. Dyer, Mandeville, LA (US); David Silverblatt, Chatanooga, TN (US)

Correspondence Address: JACOBSON HOLMAN PLLC, 400 SEVENTH STREET N.W., SUITE 600, WASHINGTON, DC, 20004, US

(21) Appl. No.: 10/859,142

(22) Filed: Jun. 3, 2004

Related U.S. Application Data
(60) Provisional application No. 60/476,490, filed on Jun. 6, 2003.

(51) Int. Cl. H01R 11/00

(52) U.S. Cl. 439/502

(57) ABSTRACT

A vending machine wiring system including a modular wiring harness and a mating, modular power cord that is non-integral with the wiring harness. The wiring harness includes a junction box housing a compressor socket, a pair of quick-disconnect tabs for connection to a thermostat or refrigeration relay, and a plurality of power leads of different configurations for use in corresponding types of vending machine. The wiring harness also includes a short, integral power cord that extends from the junction box, and that terminates in a first electrical connector. The modular power cord includes a cable, a standard grounded plug at one end of the cable of a type insertable into a wall receptacle and a second electrical connector at the other end of the cable configured for mating with and quick release from the first electrical connector. The cable is made with wire having an appropriate gauge for the current used by vending machines.

### CROSS-REFERENCE TO RELATED APPLICATIONS

The present patent application is based on, and claims priority from, U.S. provisional Application No. 60/476,490, Jun. 6, 2003, which is incorporated herein by reference in its entirety.

### COPYRIGHTED MATERIAL

Not applicable.

### BACKGROUND OF THE INVENTION

1. Field of the Invention

The present invention relates to vending machines. More specifically, the invention relates to vending machine wiring systems.

2. Related Art

In prior art vending machine wiring systems, a wiring harness includes a connection for each power point on the vending machine, as well as an integral, long power cord that plugs into a wall outlet. The problem with this type of wiring harness is that the long power cord is easily damaged, and being integral with the wiring harness, cannot be replaced without replacing the wiring harness as well.

U.S. Pat. No. 6,478,614 discloses a male/female cord that connects to an appliance wiring system and then is plugged into a wall receptacle.

U.S. Pat. No. 3,141,713 to Mendelson, U.S. Pat. No. 3,629,789 to Szeremy, U.S. Pat. No. 4,912,747 to Sakama et al., and U.S. Pat. No. 6,200,155 to Chudkosky et al. disclose cords that have a female receptacle on one end and a male connector on the other.

U.S. Pat. No. D466,867 discloses an extension cord with two forms of connection.

It is to the solution of these and other problems that the present invention is directed.

### SUMMARY OF THE INVENTION

It is accordingly a primary object of the present invention to provide a modular wiring harness and modular long power cord for vending machines, which are easily connected to and separated from each other.

It is another object of the present invention to provide a modular wiring harness and modular power cord for vending machines, wherein the wiring harness is universal to fit many types of vending machines.

It is still another object of the present invention to provide a modular wiring harness and modular power cord for vending machines, wherein the power cord can be replaced without also replacing the wiring harness.

These and other object of the invention are achieved by provision of a vending machine wiring system including a modular wiring harness and a mating, modular power cord that is non-integral with the wiring harness. As used herein, “modular” refers to a component designed with standardized or conventional elements and/or dimensions, so as to be interchangeable and/or usable with other modular components, as for easy assembly and repair or flexible arrangement and use. Such a modular component may also include non-standard or non-conventional elements. Thus, the modular wiring harness can be retrofit to, or used in the remanufacturing of, many types of vending machines.

The wiring harness includes standardized or conventional elements of a wiring harness including a junction box housing a compressor socket and a pair of quick-disconnect tabs extending from the junction box for connection to a thermostat or refrigeration relay, and at least one power lead for connection to the vending machine.

In order to permit the wiring harness to be retrofit to, or used in the remanufacturing of, many types of vending machines, the wiring harness preferably is provided with a plurality of power leads, each being of a different configuration for use in a corresponding type of vending machine. The wiring harness also includes a short, integral power cord that extends from the junction box, and that terminates in a first electrical connector.

The modular power cord includes a cable, a standard grounded plug at one end of the cable of a type insertable into a wall receptacle and a second electrical connector at the other end of the cable configured for mating with and quick release from the first electrical connector. The cable is made with wire having an appropriate gauge for the current used by vending machines. As used herein, “cable” refers to a bound or sheathed group of mutually insulated conductive wires, and “cord” refers to a cable fitted with a connector at at least one of its two ends.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a wiring diagram illustrating a universal modular wiring harness and modular power cord in accordance with the present invention.

FIG. 2 is a diagrammatic view of a vending machine incorporating the universal modular wiring harness and modular power cord of FIG. 1.

FIG. 3 is a perspective view of a universal modular wiring harness and modular power cord in accordance with the present invention.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

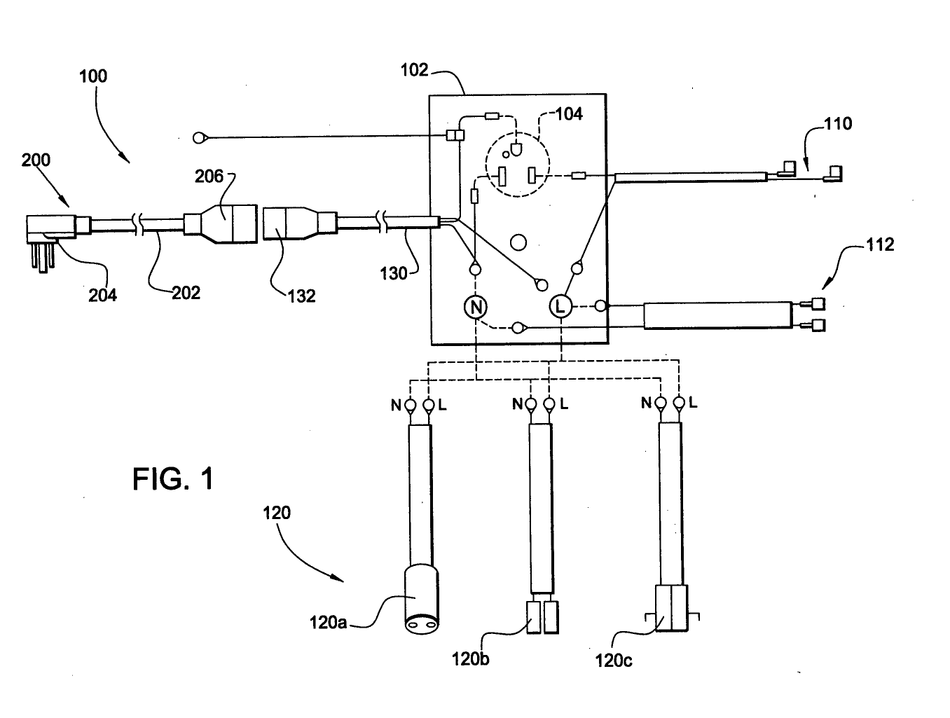

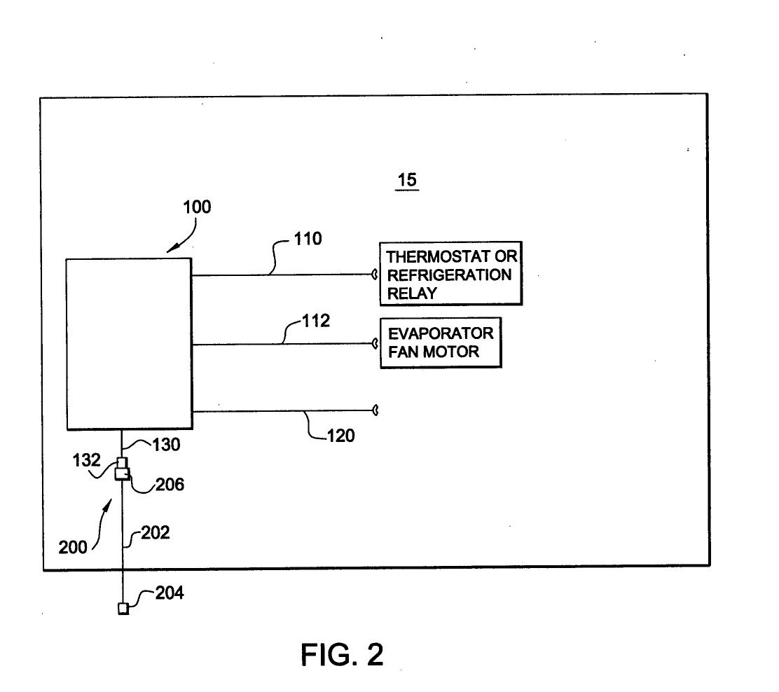

Referring now to FIGS. 1 and 2, there is shown a wiring diagram for a wiring system for a vending machine 15 in accordance with the present invention. The vending machine wiring system 10 includes a modular wiring harness 100 and a mating, modular power cord 200 that is non-integral with the wiring harness 100. The wiring harness 100 includes standardized or conventional elements of a wiring harness including, for example, a junction box 102 housing a compressor socket 104 and a pair of quick-disconnect tabs 110 extending from the junction box 102 for connection to a thermostat or refrigeration relay, and at least one power lead 120 for connection to the vending machine 15.

In order to permit the wiring harness 100 to be retrofit to many different types of vending machines (for example, vending machines made by Royal Vendors, Dixie-Narco, and Vendo) or to be used in the remanufacturing of many different types of vending machines, the wiring harness 100 can be provided with components that are required by some, but not other types of commercially available vending machines. For example, the wiring harness 100 can include a pair of quick disconnect tabs 112 extending from the junction box 102 for connection to an evaporator fan motor. The quick disconnect tabs 112 for an evaporator fan motor are needed for vending machines made by Royal Vendors and Dixie-Narco, but are not used by vending machines made by Vendo.

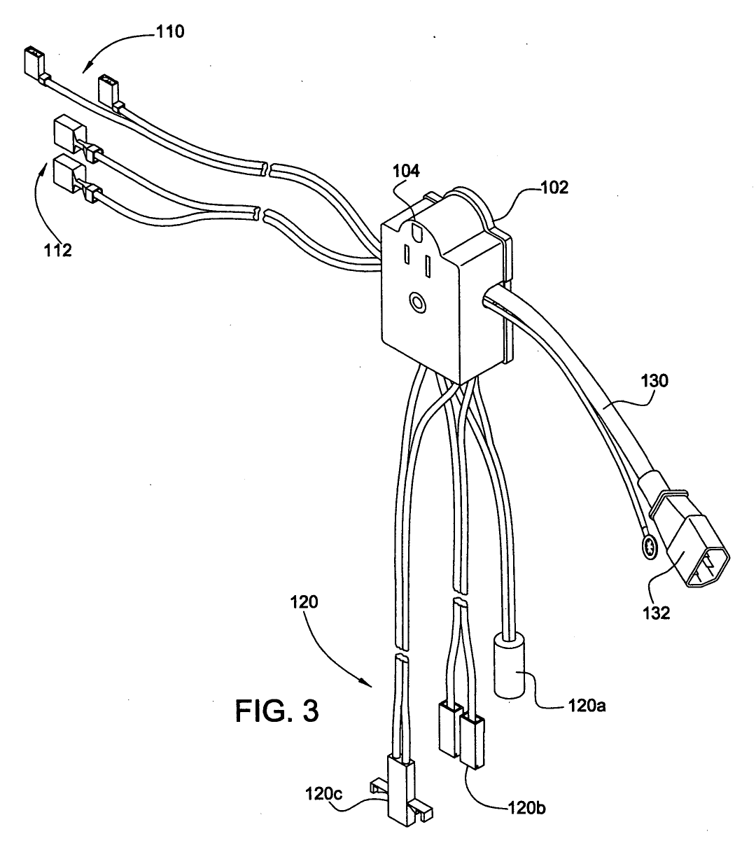

Different vending machine manufacturers utilize differently configured power leads. In order to permit the wiring harness 100 to be retrofit to, or used in the remanufacturing of, many types of vending machines, the wiring harness 100 preferably is provided with a plurality of power leads 120, each being of a different configuration for use in a corresponding type of vending machine. The wiring harness 100 shown in FIGS. 1, 2, and 3 includes power leads 120a, 120b, and 120c used respectively by Dixie-Narco, Royal Vendors, and Vendo.

It will be appreciated by those of skill in the art that a wiring harness 100 in accordance with the present invention need not be “universal” but can be made with a single power lead that is specific to a particular type of vending machine.

In addition to the standardized or conventional elements, the wiring harness 100 in accordance with the present invention includes a short, integral power cord 130 that extends from the junction box 102, and that terminates in a first electrical connector 132.

The modular power cord 200 includes a cable 202, a standard grounded plug 204 at one end of the cable 202 of a type insertable into a wall receptacle and a second electrical connector 206 at the other end of the cable 202 configured for mating with and quick release from the first electrical connector 132. The cable 202 is made with wire having an appropriate gauge for the current used by vending machines.

In order to prevent the modular wiring harness 100 from being used with an extension cord with too small a gauge, the second electrical connector 206 preferably is of a type only found on a commercially available or custom power cord having wire with an appropriate gauge for the current used by vending machines. An example of such a power cord is the type used for connecting computers and computer components (such as printers) to standard wall receptacles such as 120V grounded receptacles. This standard power cord utilizes heavy duty 18 AWG cable, a three-pin shroud IEC-320-C13 female connector at one end, and a three-prong grounded plug NEMA 5-15-P male connector at the other end. With this type of standard power cord, the three-pin shroud female (IEC-320-C13) connector is the second electrical connector 206 of the invention, and the first electrical connector 132 is a mating IEC 320 C14 male connector. A European 220 plug/receptacle combination could also be used as the first and second connectors, the power cord being provided at its other end with a standard American 120V grounded plug.

A method of retrofitting or remanufacturing a vending machine equipped during original manufacture with an original wiring harness (that is, a wiring harness with an integral, long power cord) comprises removing the original wiring harness, and replacing the original wiring harness with the modular wiring harness 100 and modular power cord 200 in accordance with the present invention. Because the modular wiring harness 100 and modular power cord 200 are provided with mating quick-release first and second connectors 132 and 206, the modular wiring harness 100 installed in the vending machine can be easily separated from the modular power cord 200.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A vending machine wiring system comprising:
a modular wiring harness including at least one power lead for connection to the vending machine and an integral power cord, the integral power cord terminating in a first electrical connector; and
a modular power cord that is non-integral with the wiring harness, the modular power cord including a cable having wire with an appropriate gauge for current used by vending machines, a grounded plug at one end of the cable of a type insertable into a standard wall receptacle, and a second electrical connector at the other end of the cable configured for mating with and quick release from the first electrical connector.

2. The wiring system of claim 1, wherein the wiring harness further includes a junction box housing an electrical socket and a pair of quick disconnect tabs extending from the junction box for connection to one of a thermostat relay and refrigeration relay, the at least one power lead and the integral power cord also extending from the junction box.

3. The wiring system of claim 2, wherein the wiring harness further includes a pair of quick disconnect tabs extending from the junction box for connection to an evaporator fan motor.

4. The wiring system of claim 1, wherein the second electrical connector is of a type only found on a power cord having wire with an appropriate gauge for the current used by vending machines.

5. The wiring system of claim 4, wherein the second connector is a three-pin Shroud IEC-320-C13 Female connector.

6. A vending machine wiring system comprising:
a modular wiring harness including a plurality of components enabling it to be used with a number of different types of vending machines and an integral power cord, the integral power cord terminating in a first electrical connector; and
a modular power cord including a cable having wire with an appropriate gauge for current used by vending machines, a grounded plug at one end of the cable of a type insertable into a standard wall receptacle, and a second electrical connector at the other end of the cable configured for mating with and quick release from the first electrical connector.

7. The wiring system of claim 6, wherein the plurality of components includes at least one power lead for connection to the vending machine, a junction box housing an electrical socket, a pair of quick disconnect tabs extending from the junction box for connection to one of a thermostat relay and refrigeration relay, and a pair of quick disconnect tabs extending from the junction box for connection to an evaporator fan motor, the at least one power lead and the integral power cord also extending from the junction box.

8. The wiring system of claim 6, wherein the second electrical connector is of a type only found on a power cord having wire with an appropriate gauge for the current used by vending machines.

9. The wiring system of claim 8, wherein the second connector is a three-pin Shroud IEC-320-C13 Female connector.

10. A vending machine wiring system comprising:
a wiring harness;
a long power cord that is non-integral with the wiring harness and having a plug at one end of a type insertable into a standard wall receptacle; and
a quick-release plug and receptacle system for mating and quick release of the wiring harness and the power cord.

11. The wiring system of claim 10, wherein the wiring harness is modular to enable it to be retrofit to, or used in the remanufacturing of, many types of vending machines.

12. The wiring system of claim 10, wherein the quick-release plug and receptacle system is of a type used only with a power cord having wire with an appropriate gauge for the current used by vending machines.

13. A method of retrofitting or remanufacturing a vending machine equipped during original manufacture with an original wiring harness, comprising the steps of:
(a) removing the original wiring harness; and
(b) replacing the original wiring harness with:
(1) a modular wiring harness including at least one power lead for connection to the vending machine and an integral power cord, the integral power cord terminating in a first electrical connector; and
(2) a modular power cord including a cable having wire with an appropriate gauge for current used by vending machines, a grounded plug at one end of the cable of a type insertable into a standard wall receptacle, and a second electrical connector at the other end of the cable configured for mating with and quick release from the first electrical connector.

14. A method of retrofitting or remanufacturing a vending machine equipped during original manufacture with an original wiring harness, comprising the steps of:
(a) removing the original wiring harness; and
(b) replacing the original wiring harness with:
(1) a modular wiring harness including at least one power lead for connection to the vending machine and an integral power cord, the integral power cord terminating in a first electrical connector; and
(2) a long power cord that is non-integral with the wiring harness and having a plug at one end of a type insertable into a standard wall receptacle; and
(3) a quick-release plug and receptacle system for mating and quick release of the wiring harness and the power cord.

15. A method of retrofitting or remanufacturing a vending machine equipped during original manufacture with an original wiring harness, comprising the steps of:
(a) removing the original wiring harness; and
(b) replacing the original wiring harness with:
(1) a wiring harness;
(2) a modular power cord that is non-integral with the wiring harness, the modular power cord including a cable having wire with an appropriate gauge for current used by vending machines, a grounded plug at one end of the cable of a type insertable into a standard wall receptacle, and a second electrical connector at the other end of the cable configured for mating with and quick release from the first electrical connector.

16. A vending machine having a wiring system comprising:
a wiring harness;
a long power cord that is non-integral with the wiring harness and having a plug at one end of a type insertable into a standard wall receptacle; and
a quick-release plug and receptacle system for mating and quick release of the wiring harness and the power cord.

17. The vending machine of claim 16, wherein the wiring harness is modular to enable it to be retrofit to, or used in the remanufacturing of, many types of vending machines.

18. The wiring system of claim 16, wherein the quick-release plug and receptacle system is of a type used only with a power cord having wire with an appropriate gauge for the current used by vending machines.
